(19) United States
(12) Patent Application Publication
(10) Pub. No.: US 2015/0183451 A1
(43) Pub. Date: Jul. 2, 2015

(54) Thematic, Interactive, Adjustable Handle Extension For Wheeled Device

(71) Applicant: Nathan Stierli, Honolulu, HI (US)

(72) Inventor: Nathan Stierli, Honolulu, HI (US)

(21) Appl. No.: 14/494,589

(22) Filed: Sep. 24, 2014

Related U.S. Application Data
(60) Provisional application No. 61/921,460, filed on Dec. 28, 2013.

(51) Int. Cl. B62B 9/20

(52) U.S. Cl. CPC B62B 9/20

(57) ABSTRACT

In one aspect, a themed handle extension device for making pushing a wheeled device for carrying a baby/toddler more entertaining and/or comfortable. One preferred device embodiment may be aeronautically or video-game themed. The device may comprise a top end comprising a gripping area and a bottom end comprising a connecting means for adjustably attaching to a wheeled device's handle. One embodiment may be inclinable forward and backward, and another embodiment may be tiltable sideways, and embodiments may comprise means for locking into said inclined and/or tilted positions. One mounting means embodiment may be configured to securely mount to different handle sizes. In one embodiment, the device may comprise a pair of adjustable handle extensions for pushing the wheeled device more comfortably. Some embodiments may also be configured to receive input signals by the pressing of buttons, which may cause for example sounds to be emitted from a sound emitting means.

### CROSS-REFERENCE TO RELATED APPLICATIONS

This U.S. Non-Provisional Utility Patent Application claims the benefit, under 35 U.S.C. §119, of United States Provisional Patent Application No. 61/921,460 filed Dec. 28, 2013, the contents of which are incorporated herein by this reference in their entireties.

### FIELD OF INVENTION

The present invention is in the technical field of handle extensions. More particularly, the present invention relates to accessories for wheeled devices for pushing a baby or toddler.

### BACKGROUND OF INVENTION AND DESCRIPTION OF PRIOR ART

Many wheeled devices for pushing babies or toddler share the same basic designs and dimensions. The typical wheeled device for pushing a baby or toddler (i.e., stroller), for example, normally comprises a seat, at least three wheels—with the wheels usually arranged with two or more back wheels and one or more front wheels and the front wheel(s) being horizontally swivelable to facilitate direction change—and a frame connecting the seat to the wheels, which frame comprises handles or a handle bar normally even with or posterior to the position of the back wheels. Some frames incorporate transversely aligned crossbar handles; other frames may comprise two semi-vertically aligned handles, each handle generally located at opposite points of the furthest transverse edges of the device. A transversely aligned handle may provide a person pushing the wheeled device with several different handle positions to grip along the handle bar, yet may be limited to the transverse orientation of the handle, which might for example only allowing horizontal gripping and at a certain height. On the other hand, the semi-vertically aligned handles may usually provide two specific and possibly-comfortable positions that the hands may grip, but may often be limited to just that pair of possible handle positions. Few wheeled devices for carrying a baby/toddler allow both transversely aligned and vertically aligned handles, as well as a wide range of handle orientations that may be adjusted and customized according to pusher preference. Moreover, few if any handle extension accessories for pushing a baby/toddler in a wheeled device exist that achieve the same objectives, and those that might possibly do so nevertheless entail other disadvantages.

### SUMMARY OF THE INVENTION

One disadvantage of prior art wheeled devices for pushing a baby/toddler and accessories thereof is that the initial excitement of such pushing can wear off and unfortunately become over time for some pushers a less enjoyable activity. For example, some reluctant wheeled device pushers would rather be flying a fighter jet or having some other adrenaline-pumping experience, or where such activities are not possible, playing a video game simulating such flight and/or other engaging and possibly thrilling experience(s). This state of less-than-optimum enjoyment from pushing a baby/toddler in a wheeled device is not only unfortunate for the pusher, who may oftentimes end up pushing the wheeled device regardless of the amount of derived pleasure, but may also lead to such pushing with less frequency and/or for decreased periods of time, possibly depriving a baby/toddler of an enjoyable, sensory-stimulating experience with the world beyond the confines of a home. Although some prior art devices incorporate some ergonomic features designed in limited manners to make pushing a wheeled device for carrying a baby/toddler more comfortable, few such pushing devices or accessories make pushing more pleasurable by engaging the attention and/or imagination of the person pushing the device (as well as potentially the baby-toddler being pushed), by for example simulating to some small extent other pleasurable activities (such as those mentioned above).

Moreover, prior art features intended to provide comfort (as opposed to entertainment and/or stimulation), such as some prior art handles that might be allegedly-ergonomically designed, may not actually provide optimal comfort for some pushers (such as persons of certain heights and arm lengths) because of fixed positions, or may not provide a sufficiently wide range of grips by allowing the handle positions to be adjusted, or may not offer the benefits of both vertically aligned handles and a horizontally aligned handle bar. For example, since most wheeled devices for carrying a baby/toddler are designed so that the height of the handle is around the midsection of a person of a certain height, a person taller than that height may have to stoop or otherwise somehow reach farther downward in order to push, which might result in discomfort. In addition, a flatly-transversely aligned handle bar (a level bar) may often require a pusher gripping the level handle so that the elbows must point out to some degree toward the sides (more towards the frontal plane axis), which over a prolonged time period may be uncomfortable for some and may engage the forearm muscles more than desirable. Semi-vertically aligned handles, on the other hand, may be set at a substantially similar height as a transversely-aligned handle bar and allow a person to grip the handles with fingers basically vertically oriented, and with the arm members bending at the elbows more along a sagittal plane axis. However, said semi-vertically handles may have a limited number of vertical positions. Thus, few prior art wheeled devices have handles with adequately-adjustable positions. Persons pushing such wheeled devices, however, often have different heights and arm lengths so that the handle configurations of a wheeled device that might be comfortable for one person may often be uncomfortable and awkward for another person.

Although some handle extensions allow the pusher of a wheeled device to steer with one hand, they normally do not incorporate features allowing a pair of such handles to be strategically placed in positions intended to provide certain comfort. For example, a pair of handles extensions could be positioned along the same transverse axis, at equal distances from a person's body, and at a height designed for the elbows to bend along the sagittal plane to allow a comfortable pushing position with the elbows held relatively close to the body. Other prior art handle extensions might be limited by not allowing a pusher the benefit of being able to grip with both hands both a horizontally aligned bar at one time and vertically or semi-vertically-aligned handles at another time, with minimal readjusting required. Other prior art handle extensions have other position-limitations, such as not providing vertically aligned handles for both hands, and not allowing a vertically aligned handle to adjust positions over a transverse axis. Moreover, such alternative positions are desirable because among other reasons they present pushers with more options of potentially comfortable and otherwise beneficial pushing positions..

One aspect of the device described herein comprises a novel themed handle extension for a wheeled device for carrying a baby/toddler, for making pushing and steering the wheeled device more pleasurable to the pusher. In one embodiment, the handle extension may be aeronautically or video-game themed, with the device resembling a joystick. Similar to some functional joysticks, one device embodiment may receive input signals by the user (by for example the user pressing buttons), for performing certain functions, such as playing through a speaker recorded sounds related to the chosen theme (and/or turning on certain lights of the device), or other preferred sounds of the pusher. Thus, one embodiment of the device comprises interactive controls, which may have certain benefits such as engaging the attention of the person pushing and/or the baby or toddler being pushed. Sounds in one device embodiment may be preselected according to anticipated popularity among certain consumer-demographics, or the user/pusher may select what different sounds are played, which selection of sounds might be chosen from those stored on an interchangeable memory card, which might be changed by the insertion of the card into a reader. In another embodiment, the sounds may be selected wirelessly using electronic means (for example, by utilizing a user's cellular phone and data and/or programs stored thereon).

In another aspect, the device may comprise a pair of handle extensions for pushing the wheeled device, which may provide a variety of advantageous handle positions for more comfortable pushing. The pair of handle extensions may comprise bottom ends having connecting means, which connecting means, in one embodiment, may be clamps (including a broad variety of clamps). The connecting means of the device may in some embodiments be configured for mounting to handles more securely so that when force is applied to push the wheeled device the handles may remain connected and intact. As further described below, one embodiment for mounting to handle bars (for example, handle bars with a cross section having rounded edges) may comprise a clamp comprising an oval-shaped interior and configured to clamp so that secure contact is made on several oppositely points of the handle bar, so that when pushing force is applied to the handle extensions the device remains mounted stably on the handle. The connecting means in one embodiment may also be configured for mounting to handles of different dimensions and sizes, such as for example, in the case of the aforementioned oval-shaped clamping embodiment, by comprising a means for adjusting the diameter of the oval according to the diameter or width of a particular handle having a cross section with rounded edges. In another embodiment the connecting means may comprise a clothespin-type clamp.

Thus, in a related embodiment, a pair of handle extensions may clamp to a horizontally aligned handle bar or crossbar, thereby allowing a user to grip either the horizontally aligned handle bar or the vertically aligned handles securely fastened to handle bar but spaced a desired distance apart. Such vertically aligned handles spaced a certain distance apart and at a certain height may provide more comfortable gripping positions to some users, such as for example allowing pushing the stroller while bending the elbows along the sagittal plane, without the wrists and forearms arms having to tilt inward, and with the handle extensions mounted and spaced another predetermined distance apart, potentially allowing the user to hold the elbows in closer to the body, which may be a more comfortable position for some users. Thus the transverse separation of the handles may be adjusted according to user preference. For example, if a person (perhaps a person having less girth) pushing the wheeled device would like to have the pair of handle extensions positioned so that the elbows could be held closer to the body, the handle extensions might be positioned so there is less distance in between them. Moreover, with the pair of handle extensions the same distance from a person's body, the forces acting on the arm members and body may be symmetrically distributed, which balanced position some users may find more comfortable.

Furthermore, the handles might need not be restricted to precisely vertical positions (e.g., ninety degrees from the horizontal), but in one embodiment may range from 60-90 degrees from the horizontal. Another related embodiment of the handle extension device may have several adjustable settings of forward and backward inclination, which inclination may occur primarily along the sagittal plane if the device is attached to a horizontally aligned handle bar (or more along the transverse plane if attached to a semi-vertically aligned handle tubular section). Said adjustable inclination may be achieved through a variety of means and structural configurations (one of which is described in greater detail below). The vertically aligned handle extensions, extending above the lower horizontal handle bar, may also be more comfortable for a taller person pushing the wheeled device carrying a baby/toddler, who may not need to reach as far downward in order to engage in a pushing motion. In addition, for a wheeled device for carrying a baby/toddler that has two vertically (or semi-vertically) aligned handles, the pair of handle extensions may provide transverse handle grips positioned according to user preference.

In addition to forwards and backwards inclination, one handle extension embodiment has several adjustable settings of sideways inclination, so that the handles may, for example, tilt inward toward one another according to user preference and comfort. More specifically, if the sideways/tilt adjustable embodiment of the handle extension device were attached to a horizontally aligned handle bar it would tilt inward along the frontal plane, or basically parallel to the axis of the transversely aligned handle bar. One related device embodiment may also “lock” into one of several such forward/backward inclined and/or sideways-tilted settings or positions. Some buttons or similar means of one embodiment of the device may also allow unlocking/locking into said positions or settings.

In one embodiment, the handles may comprise indented grips for comfort. In another embodiment, the handles may comprise storage compartments for securing small items, such as for example, keys, baby wipes, etc.

The above described embodiments are considered that of some embodiments only. It is understood that the embodiments shown in the drawings and described above are merely for illustrative purposes and not intended to limit scope. Alterations and modifications, therefore, and such further applications as would occur to those skilled in the relevant art(s), are also contemplated.

### BRIEF DESCRIPTION OF THE DRAWINGS

FIG. 1 is a side view of a handle extension device embodiment.

FIG. 2 is a right side-front perspective view of the device of FIG. 1.

FIG. 3 is a left side-front perspective view of the device of FIG. 1.

FIG. 4 illustrates the device of FIG. 1 in its environment of use, attached to the handle of, and being used to push, a wheeled device for carrying a baby/toddler.

FIG. 5 is a side view of a handle extension device embodiment configured to incline forward and backward.

FIG. 6 is a perspective view of a pair of handle extension device embodiments attached to semi-vertically aligned handles.

FIG. 7 is a perspective view of a pair of handle extension device embodiments that may tilt sideways.

FIG. 8 is a close up perspective view of a means for inclining the device forwards and backwards.

FIG. 9A is a close up side view of a connecting means embodiment clamped to a handle bar.

FIG. 9B is a close up side view of the connecting means embodiment of FIG. 9A, clamped to a smaller handle bar than the handle bar of FIG. 9A.

### DETAILED DESCRIPTION OF THE PREFERRED EMBODIMENTS

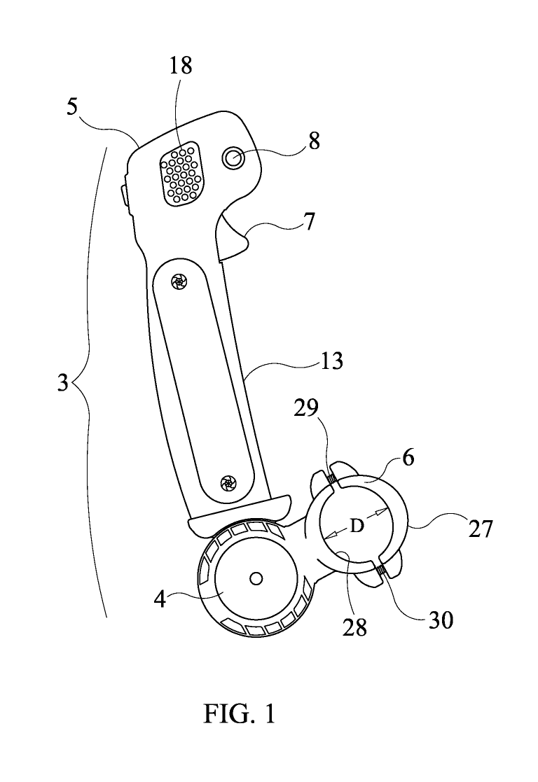

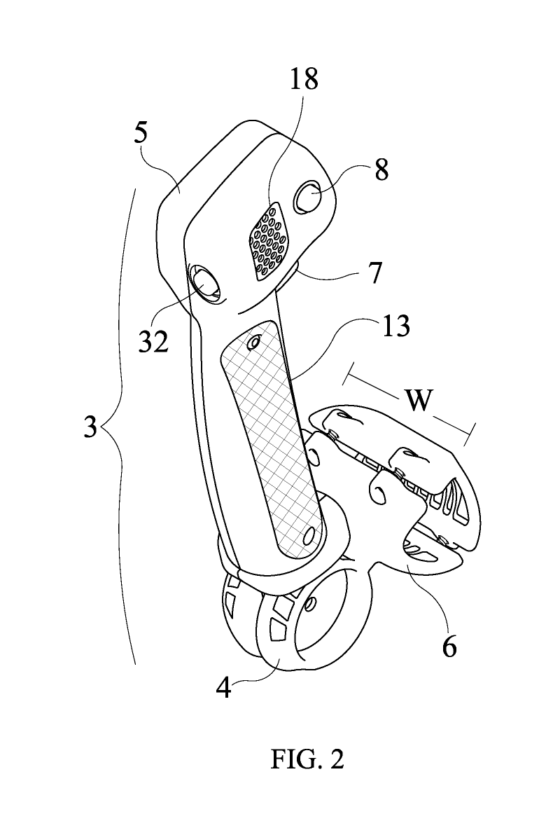

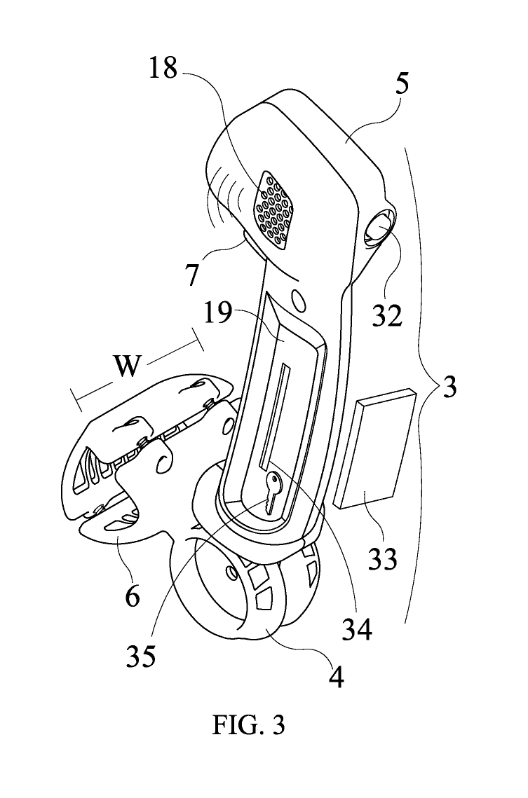

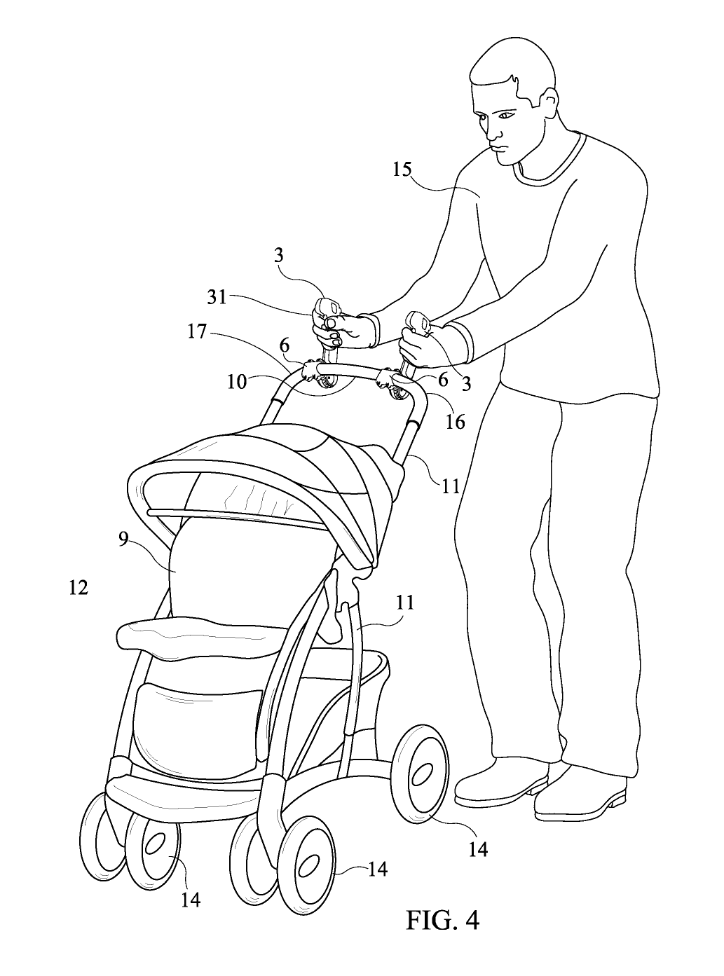

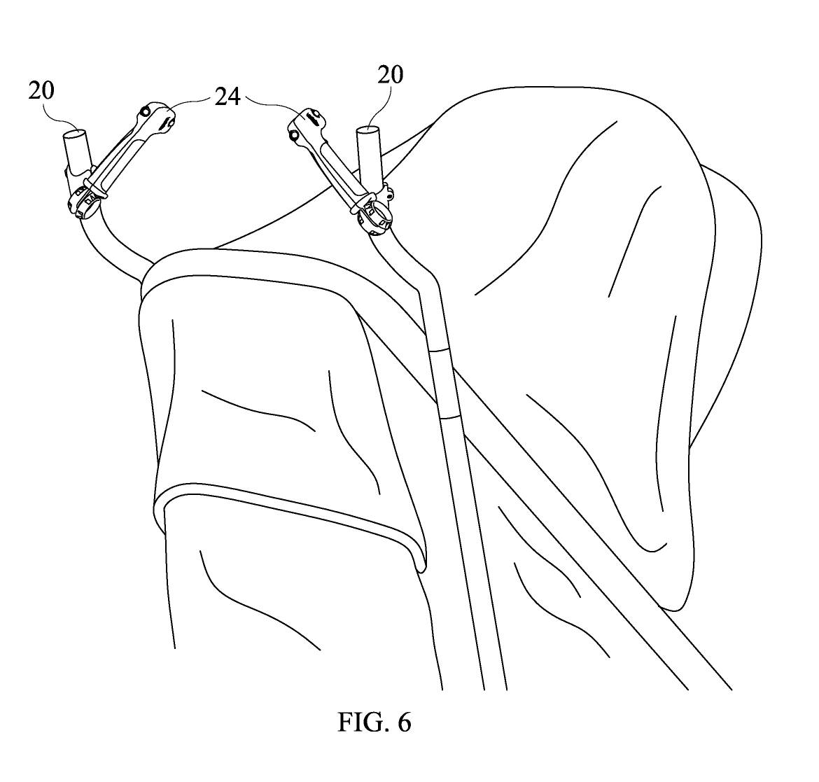

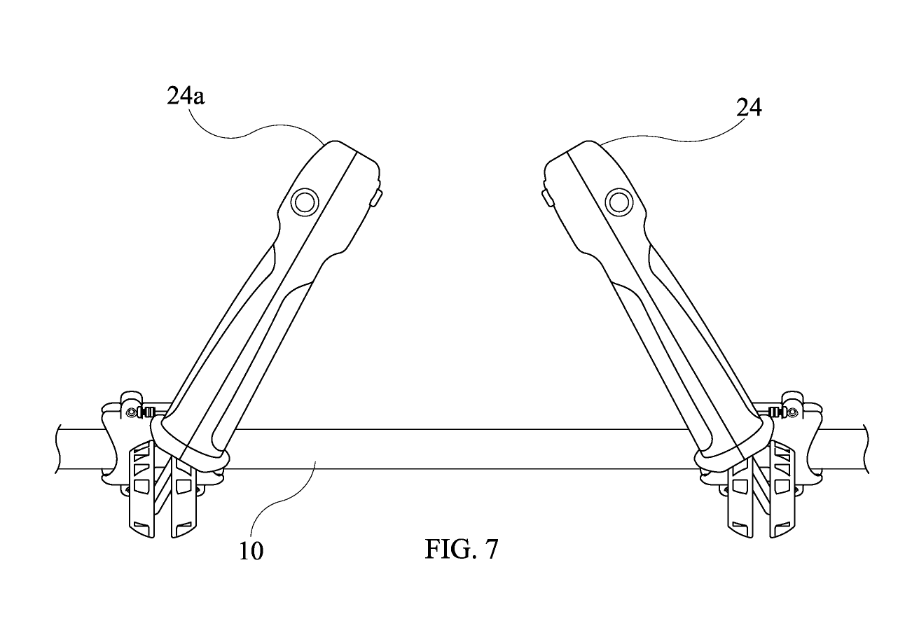

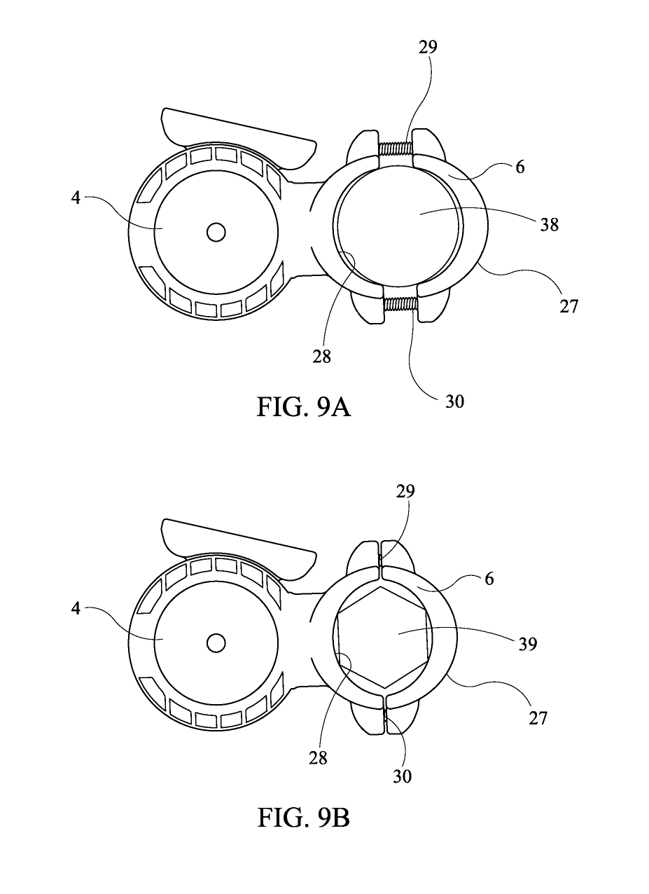

Turning to the figures, FIG. 1 illustrates an aeronautically-themed handle extension device embodiment 3, comprising a bottom end 4 and a top end 5. The bottom end 4 may comprise a connecting means such as (in the embodiment shown) one type of clamp 6. The clamp 6 may be strategically shaped for attaching/mounting/fastening to several different sizes of handles. More specifically, in the embodiment shown, the clamp 6 may comprise essentially two halves 27, 28 of an oval connected on opposite sides by screws 29, 30, the tightening of which may decrease the diameter D of the oval interior so that the clamp 6 may tightly apply pressure to several points of a handle 10 (or another 20 shown in FIG. 6) therein. The clamp 6 and sides of the interior oval, and the degree to which the screws 29, 30 may tighten, may all be configured for stably mounting to predetermined and common sizes of handles. In addition, as shown in FIGS. 2 and 3, the clamp 6 may comprise a width W for securely mounting to a handle 10 (as shown in FIG. 4), notwithstanding application of force by an operator/user 15. In the embodiment shown, said width W may be substantially 2.5 inches. As shown in more detail in FIGS. 9A and 9B the bottom end 4 may in one embodiment comprise a connecting means that is a clamp 6 having a design to mount to multiple sizes of handles 38, 39. For example, as shown in FIG. 9B, the screws 29, 30, may tighten in order to bring the oval comprising halves 27, 28 closer together, yet still maintain sufficient contact around multiple sides of the smaller (and potentially not-rounded) handle 39 for secure fastening/mounting.

Moreover, as shown in FIG. 1, the handle extension device 3 may also be comprised of material for providing a more comfortable grip 13 for fingers 31 (as shown in FIG. 4), and may also have interactive controls for receiving input signals from a user, which controls may be in the form of a trigger 7 or buttons 8, 32 (FIG. 4) and might perform certain functions such as, for example, making sounds, which sounds may be emitted through speakers 18 of the device 3 (or turning on lights). The type of sounds emitted may be modified according to user 15 preference, for example, by inserting a digital memory card 33 into a slot 34 for receiving and reading such a card 33 and configured to send signals to the speakers 18 for emitting the sounds. The sounds emitted through the speakers 18 by such a card 33 may be for example, the favorite sounds of the user, which may be played by the pressing of the button 8 and/or the trigger 7. As the one shown in FIG. 4, such functionality may make pushing a wheeled device 9 for carrying a baby/toddler, such, more pleasurable by for example, more closely replicating the activity of controlling a fighter jet or playing a video game. The device 3 may also comprise a storage compartment 19, as shown in FIG. 3, inside which small items may be placed, such as a key 35 (or baby wipes).

In one embodiment, as shown in FIG. 4, using the connecting means clamps 6, a pair of the handle extension devices 3 may be attached to the transversely aligned handle bar 10 of the wheeled device 9. The wheeled device 9 may present otherwise (absent the pair of handle extensions 3) limited gripping/pushing positions, having transversely aligned handle bar 10 fixed to or comprising a part of the frame 11, which frame 11 of the wheeled device 9 (like many other similar wheeled devices) may be connected to a seat 12 for carrying a baby/toddler, and to several wheels 14. A pusher 15 may choose between using a transversely aligned handle bar 10 or vertically aligned handles (i.e., the mounted handle extensions in the embodiment shown) 3. The positions of the pair of the handle extensions 3 may vary along the transversely aligned handle bar 10 according to numerous factors such as pusher 15 size, height, arm length, and preference. For example a taller person might find the vertically extended handle extensions 3 more comfortable to grip with less stooping or hunching required (which might also result in health benefits). A pusher 15 using the pair of devices may be able to keep the elbows closer to the body (and not jutting outward as much) and bent closer to a ninety degree angle along the sagittal plane by spacing the vertically aligned handles 3 so that the distance between them is somewhat less than the maximum distance between the edges 16, 17 of the transversely aligned handle bar 10. In this manner described above, the embodiment of the handle extension device 3 shown may be used to provide both more pleasure and comfort to a pusher 15 pushing a wheeled device 9 for carrying a baby/toddler.

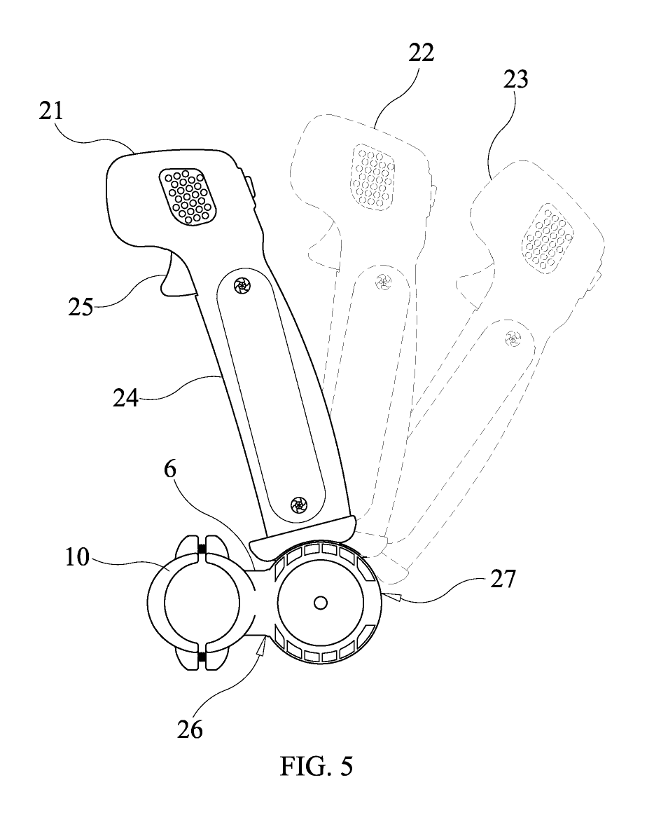

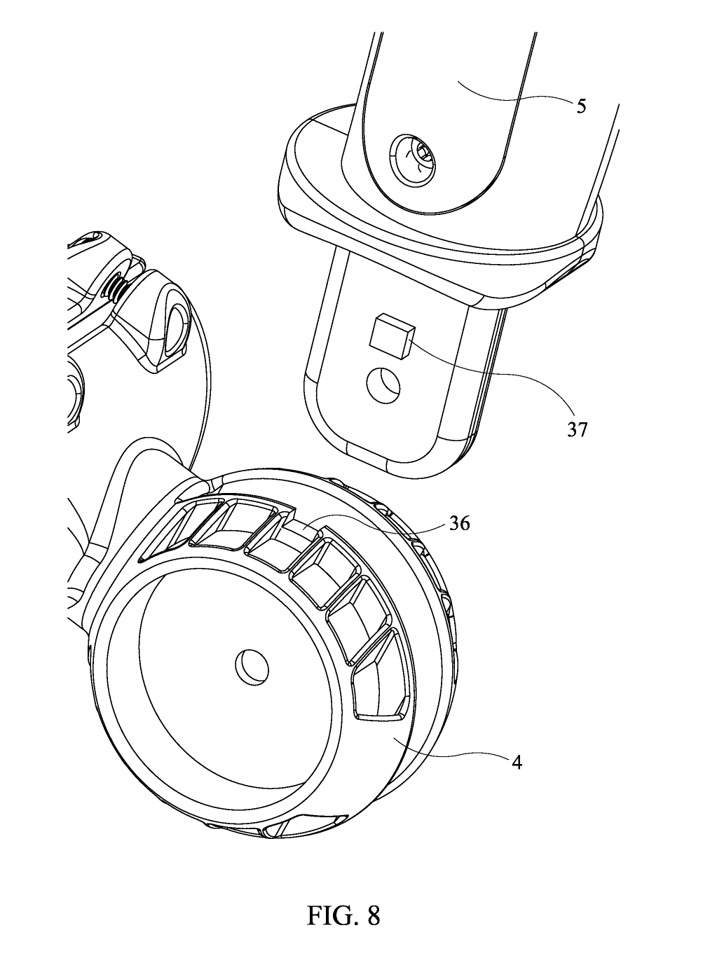

In addition to being able to adjust to different positions along a transversely aligned handle bar 10 as shown in FIG. 4 in order to create a vertically-oriented handle extension 3 perpendicular to the horizontal handle bar 10, the device 24 may also provide other potentially advantageous orientations of handle extensions. For example, the embodiment of the handle extension device 24 shown in FIG. 5 may have a means for allowing several adjustable settings of forward and backward inclination 27, for example, ranging from about 90 degrees 21, 75 degrees 22, and 61 23 degrees, from either the horizontal or (semi-)vertical axis, depending on whether the embodiment of the device 24 is attached to a transversely aligned crossbar 10 or an at least semi-vertically aligned handle section 20 (since the device 24 may attach along a semi-vertically aligned axis corresponding to an at least semi-vertically aligned handle 20, as shown in FIG. 6). Such settings of forward and backward inclination may be preset in one embodiment and, as shown in FIG. 8, may be obtained in one embodiment by the top end 5 and the bottom end 4 being attachable and detachable, with the bottom end 4 comprising a plurality of female notches 36 and the top end 5 comprising a male piece 37 for mating/connecting with a female notch 36 corresponding to the radial angle desired. In addition, in another embodiment, as shown in FIG. 5, the means for allowing the inclining handle extension device embodiment 24 to achieve one of several forward/backward inclined positions 21, 22, 23 may also comprise a means for locking 25 the device 24 into one of said positions 21, 22, 23 by for example, comprising a certain button 25 on the device 24 that may be activated by pressing.

In addition to tilting forward and backward as shown in FIG. 5, an embodiment of the device 24 may also comprise a means for tilting 27 the handle extensions 24 sideways, as shown in FIG, 7 so that, for example, a pair of handle extensions 24, 24(a) may tilt inward towards one another either while attached to an at least semi-vertically aligned handle piece 20 or along a transversely aligned handle bar 10.

I claim:

1. An themed handle extension device for mounting to a handle of a wheeled device for carrying a baby/toddler that is pushable by a person, the device comprising:
a top end and a bottom end below the top end, the top end comprising a gripping area, and the bottom end comprising a connecting means for securely and releasably attaching to the handle;
wherein, the connecting means is configured to connect to the handle so that the device is mountable in a plurality of positions along the handle;
wherein, by gripping the gripping area of the device securely mounted to the handle and applying force in a predetermined direction the wheeled device for carrying a baby/toddler moves in said direction;
wherein, the device comprises features pertaining to a theme having relevance for the person and for reminding the person of the theme while pushing; and
whereby, pushing the wheeled device using the themed handle extension device is more pleasurable to the person pushing.

2. The device of claim 1, wherein the device is aeronautically themed and resembles a joystick.

3. The device of claim 1, wherein the device further comprises interactive functionality triggered by signal inputs activated by the person.

4. The device of claim 3, wherein the top end further comprises at least one button and the interactive functionality further comprises a sound emitting means that emits at least one sound when the button is pressed.

5. The device of claim 4, further comprising a means for selecting from among several sounds playable by the sound emitting means.

6. The device of claim 5, wherein the at least one button further comprises and the interactive functionality is activated by features customarily found on a joystick.

7. The device of claim 1, wherein the device is configured to mount to the handle so that the axis of the handle extension is normal to the orientation of the handle.

8. The device of claim 7, wherein the handle of the wheeled device comprises a horizontally transverse handle bar, and the means for connecting to the handle is configured to mount at a plurality of horizontal positions along the transverse stroller handle bar so that the gripping area of the device is vertically aligned.

9. The device of claim 8, further comprising a pair of handle extension devices, each device being substantially a mirror image of the other device, for gripping with two hands so that each hand grips the gripping areas of a different one of the pair of devices, and mountable to the handle bar so that when each handle is simultaneously gripped by both of the person's hands, the person's arms are equal distances from the person's body.

10. The pair of devices of claim 9, further configured so that each device's respective gripping area is inclinable forwards and backwards.

11. The pair of devices of claim 10, further configured to lock into several predetermined gripping area positions of forward and backward inclination.

12. The pair of devices of claim 11, wherein the top ends and the bottom ends are detachable and reattachable and the bottom ends comprise a plurality of female notches, each female notch having a different angular position corresponding to a different amount of inclination, and the top ends comprise male pieces insertable into particular female notches so that the gripping areas lock into corresponding positions of inclination.

13. The pair of devices of claim 9, further configured so that the gripping areas are tiltable sideways.

14. The device of claim 1, wherein the connecting means comprises a clamp.

15. The device of claim 14, wherein the connecting means for securely and releasably attaching to the handle is configured for mounting to several different sizes and types of handles.

16. The device of claim 15, wherein the clamp comprises an oval-shaped interior having an adjustable diameter.

17. The device of claim 1, wherein the top end of the device further comprises a compartment for storing small objects.

18. A handle extension device for mounting to a handle of a wheeled device for carrying a baby/toddler that is pushable by a person, the device comprising:
a top end and a bottom end below the top end, the top end comprising a gripping area, and the bottom end comprising a clamping connecting means for securely and releasably attaching to the handle;
wherein, the connecting means is configured to connect to the handle so that the device is mountable in a plurality of positions along the handle; and
wherein, by gripping the gripping area of the device mounted to the handle and by applying force in a direction and predetermined manner the wheeled device for carrying a baby/toddler moves in said direction; and
wherein the clamping connecting means for securely and releasably attaching to the handle is configured for mounting securely to several different sizes and types of handles.

19. The device of claim 18, wherein the clamping-connecting means comprises an oval-shaped interior having an adjustable diameter.

20. The device of claim 18, wherein the mounted device is further configured so that the gripping area is inclinable forwards and backwards.

21. The device of claim 20, wherein the mounted device is further configured to lock in place in several predetermined inclined positions.

22. The device of claim 21, wherein the mounted device is further configured so that the gripping area is tiltable sideways and is lockable in place in a tilted sideways position.

23. The device of claim 22, further comprising features pertaining to a theme having relevance for the person and for reminding the person of the theme while pushing the wheeled device; whereby, pushing the wheeled device using the themed handle extension device is more pleasurable to the person pushing.

24. The device of claim 23, wherein the device is aeronautically-themed.

25. The device of claim 23, wherein the device is video-game themed and resembles a joystick.

26. The device of claim 23, wherein the device further comprises interactive functionality triggered by signal inputs input-able by the person.
